(19) United States
(12) Patent Application Publication
(10) Pub. No.: US 2008/0081616 A1
(43) Pub. Date: Apr. 3, 2008

(54) Acquisition Techniques for Wireless Communications Systems

(76) Inventors: Wen Zhao, Cupertino, CA (US); Arun G. Mathias, Sunnyvale, CA (US); Felicia Tsu, Mountain View, CA (US); Janell L. Paulson, Carlsbad, CA (US); Michael J. Stephens, San Jose, CA (US); Isabel Y. Mahe, Los Altos, CA (US)

Correspondence Address: KACVINSKY LLC;C/O INTELLEVATE, P.O. BOX 52050, MINNEAPOLIS, MN, 55402, US

(21) Appl. No.: 11/537,615

(22) Filed: Sep. 30, 2006

(51) Int. Cl. H04Q 7/20

(52) U.S. Cl. 455/432.1

(57) ABSTRACT

Techniques involving the acquisition of wireless communications systems are disclosed. For example, an apparatus may store a list of one or more preferred wireless communications systems. Upon identifying a first accessible wireless communications system that is absent from the list, the device may acquire this system. However, after this acquisition, the device may further identify a second accessible wireless communications system. If the second system is included in the list of one or more preferred wireless communications systems, the apparatus may acquire the second system.

### BACKGROUND

Mobile computing devices, such as smart phones, may provide various processing capabilities. For example, mobile devices may provide personal digital assistant (PDA) features, including word processing, spreadsheets, information synchronization (e.g., e-mail) with desktop computers, and so forth.

In addition, such devices may employ various communications technologies to provide features, such as mobile telephony, mobile e-mail access, web browsing, and content (e.g., video and radio) reception. Exemplary wireless communications technologies include cellular, satellite, and mobile data networking technologies.

Furthermore, devices may maintain communications service by roaming among different wireless systems. However, devices often have a subscriber or home system that is preferred over other systems. Accordingly, in locations where multiple systems are accessible, it is desirable to obtain communications service through preferred systems.

### BRIEF DESCRIPTION OF THE DRAWINGS

FIG. 1 illustrates one embodiment of an apparatus.

FIG. 2 is a diagram showing exemplary operational states of an apparatus.

FIGS. 3 and 4 are exemplary logic diagrams.

FIG. 5 illustrates one embodiment of a system.

### DETAILED DESCRIPTION

Various embodiments may be generally directed to techniques for selecting and acquiring wireless communications services.

For instance, embodiments may include an apparatus that stores a list of one or more preferred wireless communications systems. Upon identifying a first accessible wireless communications system that is absent from the list, the device may acquire this system. However, after this acquisition, the device may further identify a second accessible wireless communications system. If the second system is included in the list of one or more preferred wireless communications systems, the apparatus may acquire the second system. Through such features, devices may migrate their communications services and activities from less desirable (or even undesirable) systems to more preferred ones.

Embodiments may involve a variety of wireless communications technologies. These technologies may include cellular and data networking systems. Exemplary cellular systems may employ code division multiple access (CDMA), such as CDMA2000.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements, as desired for a given implementation. It is worthy to note that any reference to “one embodiment” or “an embodiment” means that a particular feature, structure, or characteristic described in connection with the embodiment is included in at least one embodiment.

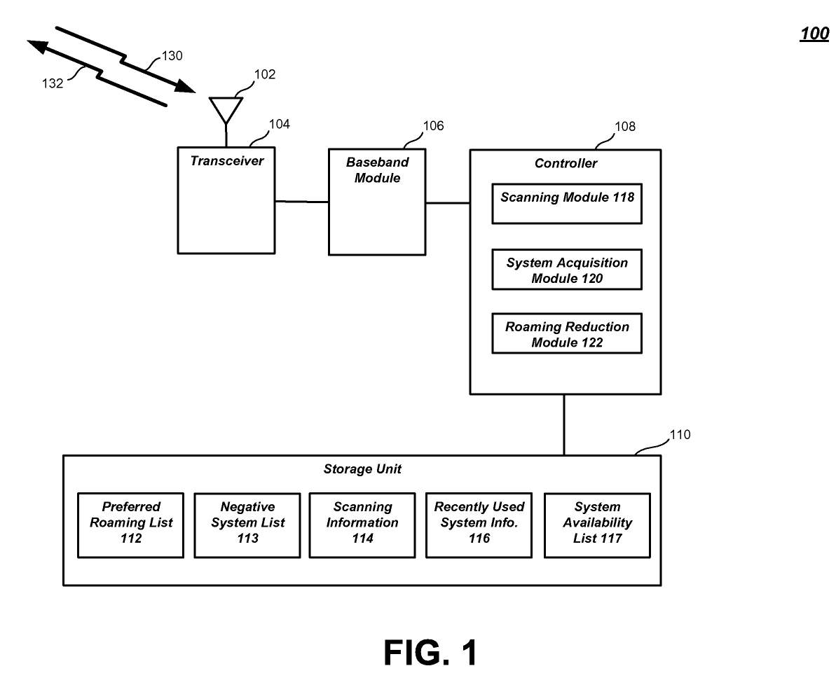

FIG. 1 illustrates an embodiment of an apparatus. In particular, FIG. 1 shows an apparatus 100 that may engage in wireless communications. Apparatus 100 may comprise various elements. In particular, FIG. 1 shows that apparatus 100 may include an antenna 102, a transceiver 104, a baseband module 106, a controller 108, and a storage unit 110. The embodiments, however, are not limited to these depicted elements.

Transceiver 104 may exchange wireless signals with one or more remote devices through antenna 102. Such devices may include one or more cellular base stations. For instance, FIG. 1 shows transceiver 104 receiving a first wireless signal 130 and transmitting a second wireless signal 132. These signals may in accordance with various cellular systems.

Exemplary cellular systems include CDMA systems, such as CDMA2000, IS-95, Wideband CDMA (WCDMA), and Universal Mobile Telephone System (UMTS). Further cellular systems include Global System for Mobile Communications (GSM) systems, North American Digital Cellular (NADC) systems, Extended Time Division Multiple Access (E-TDMA) systems, Digital Advanced Mobile Phone Service (IS-136/TDMA), Narrowband Advanced Mobile Phone Service (NAMPS) systems. However, the embodiments are not limited to these examples. For instance, transceiver 104 may additionally or alternatively communicate across other types of cellular links as well as non-cellular communications links.

Transceiver 104 may generate baseband symbols from received wireless signals, and deliver such symbols to baseband module 106. Also, transceiver 104 may receive symbols from baseband module 106 and generate corresponding signals for wireless transmission via antenna 102.

In addition to exchanging baseband symbols with transceiver 104, baseband module 106 may perform various operations on these symbols. Exemplary operations may include error correction encoding and decoding, packet encapsulation, and so forth. Moreover, baseband module 106 may operate according to various protocol(s). Such protocols may include (but are not limited to) media access control protocols, and link control protocols.

FIG. 1 shows that controller 108 is coupled to baseband module 106. Thus, controller 108 and baseband module 106 may exchange information corresponding to the symbols exchanged between baseband module 106 and transceiver 104. As a result, controller 108 may generate and process information that it exchanges with other remote devices. Examples of such devices include cellular base stations, system controllers, and user devices. Such information may be in the form of protocol data units (PDUs), formatted messages and/or the like.

Further, controller 108 may direct various operations of apparatus 100. Such actions may be based, for example, on the information it receives from other devices.

Controller 108 may include various modules. For instance, FIG. 1 shows controller 108 having a scanning module 118, a system acquisition module 120, and a roaming reduction module 122.

Scanning module 118 may perform scanning operations in which one or more systems or networks are sought. With reference to CDMA cellular networks (such as CDMA2000 networks) scanning operations involve searching one or more frequencies for pilot channels and their corresponding SYNC channels.

Pilot channels are forward link channels (i.e., channels conveying transmissions from base stations to user devices) that are modulated by only a PN spreading code. This feature allows devices acquiring a pilot channel to obtain timing references for the acquisition of other corresponding channels, such as SYNC channels. SYNC channels are forward link channels that carry messages called synchronization messages. These messages convey system timing information (e.g., pilot PN offset, system time, and long code state), as well as system information.

Thus, scanning operations may involve controller 108 directing transceiver 104 (e.g., through baseband module 106 or directly) to obtain information based on scanning information. As described below, such information may be in the form of a scanning list contained in storage unit 110.

Such scanning lists may specify certain types of scanning operations. For instance, a scanning list may specify scanning for systems that are only known to be in a particular geographic area (also referred to as a “GEO”). However, scanning lists may specify scanning operations with no such geographic restrictions.

System acquisition module 120 performs operations involving the acquisition of a system for user communications. For instance, acquisition module 120 may select a system to acquire. Upon such a selection, system acquisition module 120 may direct transceiver 104 (either directly or through baseband module 106) to acquire the system through appropriate receptions and/or transmissions. (e.g., appropriate signaling, and so forth to provide for user communications). Such operations of acquisition module 120 may be based on operations performed by scanning module 118 and/or roaming reduction module 122.

Roaming reduction module 122 may perform various operations once service is acquired with a non-preferred system. For instance, roaming reduction module 122 may initiate actions by scanning module 118 and/or system acquisition module 120 to migrate service from a non-preferred system to a preferred system.

Storage unit 110 may store various forms of information. For instance, FIG. 1 shows storage unit 110 storing a preferred roaming list (PRL) 112, a negative system list 113 scanning information 114, recently used system information 116, and system availability list 117.

Preferred roaming list (PRL) 112 may be used for system selection and acquisition. In particular, PRL 112 may include a system table and an acquisition table. The system table contains records, each of which identifies a network by its System Identification (SID) and Network Identification (NID). Each of these records may provide further information, such as a relative priority of the system of preference label (e.g., “most preferred”, “less preferred”, etc.), an associated roaming status to be indicated by the mobile device, the, and the system's geographic region.

Each record in the system table of PRL 112 may also include an acquisition index. The acquisition index identifies a corresponding record in the acquisition table. This record provides information for acquiring the corresponding system, such as frequencies and so forth.

As described above, systems listed by PRL 112 may be given different preference labels. For instance, highest priority systems may be labeled “most preferred.” Such systems are typically home or non-roaming system. However, lower priority systems (such as roaming systems) may be labeled “less preferred”.

Negative system list 113 may provide indications of “negative” systems. Such systems may be at a generic system level. For instance, such labels may be assigned to particular system identifiers, but not to more particular system identifier/network identifier pairings.

Scanning information 114 may include one or more scanning lists, which apparatus 100 may use to obtain information regarding available communications resources (e.g., available systems and/or networks). For instance, each scanning list may include one or more channel frequencies ordered according to a priority scheme. An exemplary order may be non-roaming networks followed by roaming networks (or most preferred systems followed by less preferred systems). Such scanning lists may be created from information (e.g., acquisition tables) in PRL 112.

As described above, scanning in the context of CDMA cellular networks may involve acquiring and obtaining information from SYNCH channels. Thus, scanning lists may include RF parameters (e.g., frequencies) used by such SYNCH channels.

Recently used system information 116 may store identification information (e.g., SID and/or NID) and acquisition information for one or more recently used systems. For instance, recently used system information 116 may store data for the most recently used (MRU) system.

System availability list 117 indicates systems that are accessible or available to apparatus 100. Such information may include system identifiers (e.g., SIDs and NIDs) as well as acquisition information.

The elements of FIG. 1 may be implemented in hardware, software, firmware, or in any combination thereof. For instance, one or more features of apparatus 100 may be implemented with instructions or logic (e.g., software) that is provided on a storage medium for execution by one or more processors.

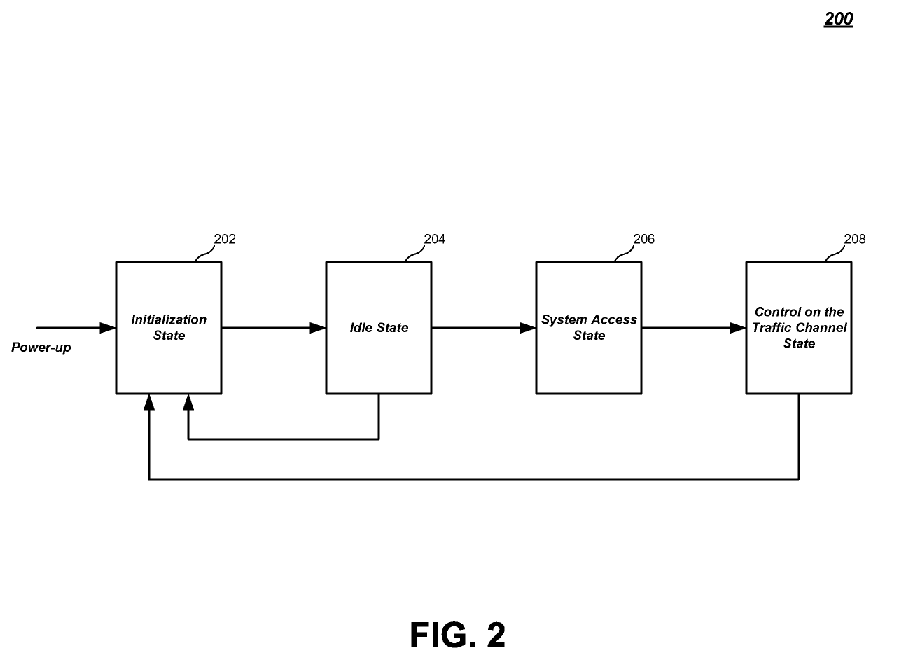

Devices and apparatuses, such as apparatus 100 may operate in various states. For instance, FIG. 2 is a diagram showing operational states of a CDMA2000 device. As shown in FIG. 2, these states include an initialization state 202, an idle state 204, a system access state 206, and a control on the traffic channel state 208 (also referred to herein as traffic state 208).

When in initialization state 202, the device selects and acquires a system. The device may enter this state upon powering up. Acquiring the system may involve receiving messages from one or more control channels transmitted by base station(s) within the system. Additionally, CDMA2000 devices may enter initialization state 202 from other states, such as idle state 204 and/or traffic state 208.

As shown in FIG. 2, the device may enter idle state 204 from initialization state 202. In idle state 204, the device monitors transmissions (e.g., control channel messages) from the acquired system. In the context of CDMA2000, such messages may be received from forward link paging, sync, and/or control channels.

From idle state 204, the device may enter access state 206. This may occur when one or more events occur. Such events may include the placing of a call, the receipt of a message, and so forth. While operating in access state 206, may both send and receive messages over control channels. With reference to CDMA2000, such channels may include forward and reverse channels (e.g., paging, sync, and/or control channels).

The device may enter traffic state 208 from access state 206. This transition may occur upon establishment of a call involving the device. In traffic state 208, the device may communicate with a base station over traffic channel(s).

As described above, CDMA2000 devices may enter into initialization state 202 upon powering up. Also, such devices may enter initialization state 202 from other states, such as such as idle state 204 and/or traffic state 208. For instance, initialization state 202 may be entered from idle state 204 if a device loses an acquired channel, such as a paging channel. Also, initialization state 202 may be entered from traffic state 208 upon termination of a call.

However, such potential transitions do not sufficiently or adequately reduce the potential of devices acquiring and communicating over disfavored systems. Accordingly, embodiments provide for further opportunities to select and/or reselect systems. With reference to FIG. 2, this may involve further events triggering entry into initialization state 202. However, the embodiments are not limited to such. For instance, system selection and/or reselection may occur in other states of FIG. 2 as well as states or modes not shown in this diagram.

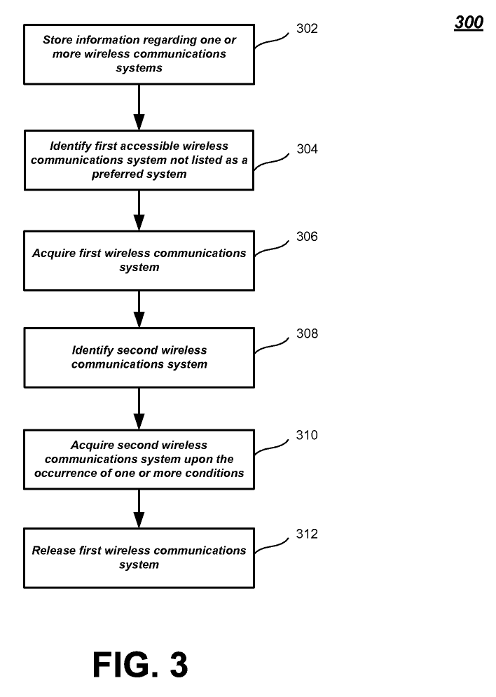

FIG. 3 illustrates an exemplary logic flow 300, which may be representative of the operations executed by one or more embodiments described herein. As shown in FIG. 3, a block 302 stores information regarding one or more wireless communications systems. This information may include lists of preferred systems, as well as lists of negative systems. With reference to FIG. 1, such information may be stored as preferred roaming list 112 and/or negative system list 113 within storage unit 110.

A block 304 identifies a first accessible wireless communications system that is not listed as a preferred wireless communications system. This identification may be achieved through a scanning operation that identifies the first accessible system through one or more received transmissions. With reference to CDMA systems (e.g., CDMA2000 systems), such transmission(s) may include one or more messages received over a paging channel and/or a SYNCH channel. However, the embodiments are not limited to this context.

A block 306 acquires the first accessible wireless communications system. Block 306 may perform this acquisition upon the occurrence of one or more conditions. Determining whether such conditions have occurred may involve accessing and/or searching the information stored by block 302.

For instance, this acquisition may be performed when the first accessible wireless communications is neither listed as a preferred wireless communications system nor a negative wireless communications system. However, this acquisition may alternatively be performed when the first accessible system is listed as a negative system, but a recently used system (such as the most recently used system) is no longer accessible (e.g., is not found through scanning operation(s)).

Acquisition of the first accessible system may involve receiving messages from one or more control channels. Such messages may be transmitted by base station(s) within the system. In addition, this may involve indicating to a user (e.g., showing on a display) that the second communications system has been acquired. However, the embodiments are not limited to such.

After acquiring the first accessible wireless communications system, a block 308 identifies a second accessible wireless communications system. This may involve one or more scanning operations. In embodiments, such scanning operations may occur periodically. As described above regarding block 304, scanning operations may result in the reception of one or more transmissions.

A block 310 acquires the second wireless communications system upon the occurrence of one or more conditions. Such condition(s) may include, for instance, the second wireless communications system being in the list of preferred wireless communications systems.

As with block 306, acquisition of the second wireless communications system by block 310 may involve receiving messages from one or more control channels. Such messages may be transmitted by base station(s) within the system. In addition, this may involve indicating to a user (e.g., showing on a display) that the second communications system has been acquired. However, the embodiments are not limited to such.

Following acquisition of the second wireless communications system, a block 312 may relinquish the first wireless communications system.

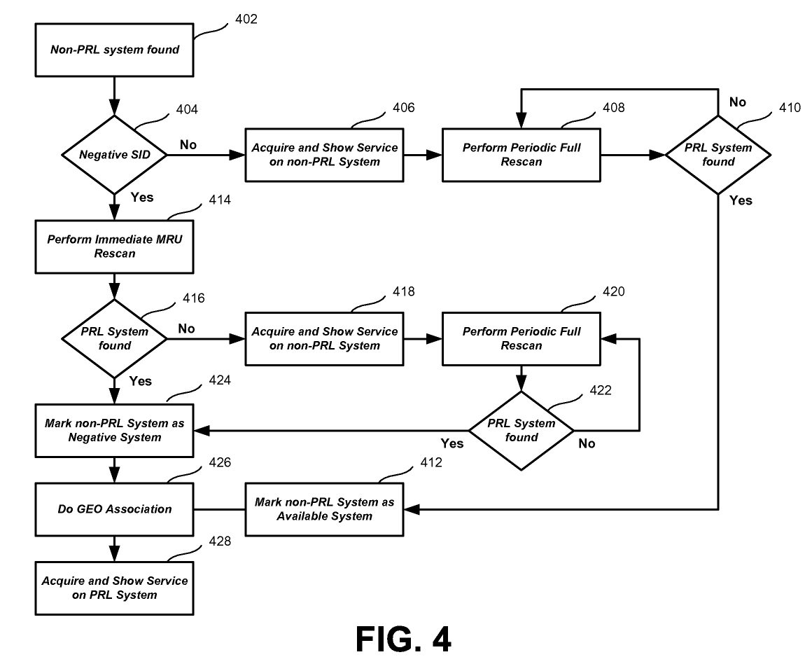

FIG. 4 illustrates a further exemplary logic flow 400, which may be representative of the operations executed by one or more embodiments described herein. For instance, such operations may be performed by a device capable of wireless communications, such as apparatus 100. FIG. 4 shows that logic flow 400 includes a block 402, which finds a wireless communications system that is not included in a preferred roaming list, such as PRL 112.

A block 404 determines whether the system is generically designated as a negative system (for instance, whether it has a negative system ID). If so, then the flow proceeds to a block 414. Otherwise, the flow proceeds to a block 406. FIG. 4 shows that block 414 scans for the most recently used (MRU) system. In the context of FIG. 1, this may involve accessing stored information, such as recently used wireless parameters 116.

As shown in FIG. 4, block 406 acquires and shows service on the system found by block 402. Following this, blocks 408 and 410 operate to periodically rescan for another accessible wireless system until a preferred one (e.g., one stored in a preferred roaming list) is found. Such rescans may be “full”. Thus they may not be limited to particular geographical indicators. As described above with reference to FIG. 1, such indicators (e.g., GEOs) may be stored in scanning information 114.

If block 410 determines that a preferred system is found, FIG. 4 shows a block 412 marking or designating the system found by block 402 as an available system. In the context of FIG. 1, this may involve storing information regarding this system in system availability list 117.

As described above, block 414 scans for the most recently used (MRU) system when the system found by block 402 is generically designated as negative. As indicated by a block 416, if the MRU system is found (or it is accessible), then a block 424 marks or designates the particular system found by block 402 (e.g., system ID and network ID) as negative. With reference to FIG. 1, this designation may be stored in negative system list 113 or preferred roaming list 112.

However, if the MRU system is not found, then a block 418 acquires the system found by block 402. An advantage of acquiring and showing services on non-PRL system 402 is that it allows the device's user to have network access when there is a lack of a preferred system. Alternatively, block 418 may be implemented so that it does not acquire the system and, therefore, no services are shown to the user.

As shown in FIG. 4, blocks 420 and 422 may follow block 418. These blocks provide periodic rescanning for another accessible wireless system until a preferred one (e.g., one stored in a preferred roaming list) is found. Such rescans may be “full”. Thus they may not be limited to particular geographical indicators.

Block 422 shows that, once a preferred system is found, the flow proceeds to block 424. As described above, block 424 marks or designates the particular system found by block 402 (e.g., system ID and network ID) as negative.

The flow of FIG. 4 shows that a block 426 may follow blocks 424 and 412. Block 426 performs a GEO association by associating the device's current geographic status (e.g., its location) with the preferred system found in either block 408 or block 420. This may involve storing the association in a list, such as preferred roaming list 112. This automatic GEO association makes the device self-adjusting to its network environment. Thus, a better user experience may occur than with a fixed preferred list strategy.

FIG. 4 further shows that a block 428 may acquire the system found in either block 408 or block 420.

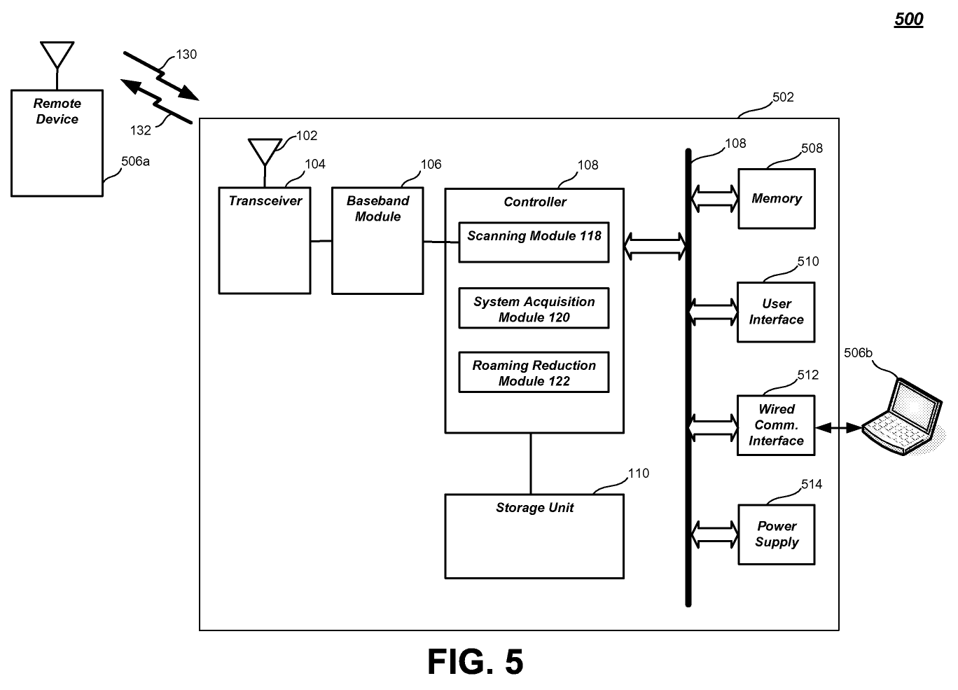

FIG. 5 illustrates an embodiment of a system 500. This system may be suitable for use with one or more embodiments described herein, such as apparatus 100 of FIG. 1, logic flow 300 of FIG. 3, and so forth. Accordingly, system 500 may engage in wireless communications. For instance, FIG. 5 shows device 502 engaging in wireless communications (e.g., telephony or messaging) with a device 506a. Device 506a may be a cellular base station, or a mobile user device. However, the embodiments are not limited to these examples. In addition, system 500 may perform various techniques, such as the ones described herein regarding system selection and acquisition.

As shown in FIG. 5, system 500 may include a device 502 and one or more remote devices 506. FIG. 5 shows that device 502 may include the elements of FIG. 1. In addition, device 502 may include a memory 508, a user interface 510, a wired communications interface 512, and a power supply 514.

Memory 508 may store information in the form of data. For instance, memory 508 may contain application documents, e-mails, sound files, and/or images in either encoded or unencoded formats. Alternatively or additionally, memory 508 may store control logic, instructions, and/or software components. These software components include instructions that can be executed by one or more processors. Such instructions may provide functionality of one or more elements in system 500. Exemplary elements include baseband module 106 and controller 108.

In embodiments, memory 508 may further comprise storage unit 110. Thus, information, such as PRL list 112, scanning list 114, recently used wireless parameters 116, and system availability list 117 may be stored by memory 508.

Memory 508 may be implemented using any machine-readable or computer-readable media capable of storing data, including both volatile and non-volatile memory. For example, memory 508 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 508 may be included in other elements of system 500. For instance, some or all of memory 508 may be included on a same integrated circuit or chip with elements of apparatus 100. Alternatively some portion or all of memory 508 may be disposed on an integrated circuit or other medium, for example a hard disk drive, which is external. The embodiments are not limited in this context.

User interface 510 facilitates user interaction with device 502. This interaction may involve the input of information from a user and/or the output of information to a user. Accordingly, user interface 510 may include one or more devices, such as a keypad, a touch screen, a microphone, and/or an audio speaker. In addition, user interface 510 may include a display to output information and/or render images/video received by device 502. Exemplary displays include liquid crystal displays (LCDs), plasma displays, and video displays.

Wired communications interface 512 provides for the exchange of information with a device 506b (e.g., a proximate device), such as a personal computer. This exchange of information may be across one or more wired connections. Examples of such connections include USB interfaces, parallel interfaces, and/or serial interfaces. In addition, interface 512 may provide for such exchanges across wireless connections(s). An infrared interface is an example of such a connection. The information exchanged with such proximate devices, may include e-mail, calendar entries, contact information, as well as other information associated with personal information management applications. In addition, such information may include various application files, and content (e.g., audio, image, and/or video).

Wired communications interface 512 may include various components, such as a transceiver and control logic to perform operations according to one or more communications protocols. In addition, communications interface 512 may include input/output (I/O) adapters, physical connectors to connect the I/O adapter with a corresponding communications medium.

Power supply 514 provides operational power to elements of device 502. Accordingly, power supply 514 may include an interface to an external power source, such as an alternating current (AC) source. Additionally or alternatively, power supply 514 may include a battery. Such a battery may be removable and/or rechargeable.

However, the embodiments are not limited to these examples.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
(a) identifying a first accessible wireless communications system, wherein the first accessible wireless communications system is absent from a list of one or more preferred wireless communications systems;
(b) acquiring the first accessible wireless communications system;
(c) identifying a second accessible wireless communications system after acquiring the first accessible wireless communications system;
(d) acquiring the second accessible wireless communications system when the second wireless communications system is included in the list of one or more preferred wireless communications systems.

2. The method of claim 1, wherein (b) comprises acquiring the first accessible wireless communications system when the first accessible wireless communications system is absent from both the list of one or more preferred wireless communications systems and a list of one or more negative wireless communications systems.

3. The method of claim 2, further comprising:
storing the list of one or more preferred wireless communications systems and the list of one or more negative wireless communications systems.

4. The method of claim 1, wherein (c) comprises performing one or more periodic scanning operations.

5. The method of claim 1, wherein (d) comprises relinquishing acquisition of the first accessible wireless communications system.

6. The method of claim 1, further comprising:
(e) designating the second accessible wireless communications system as a negative system when it has a negative system ID, and otherwise designate the second accessible wireless communications system as an available system.

7. The method of claim 1, further comprising:
scanning for a most recently used system when the first accessible wireless communications system is included in a list of one or more negative wireless communications systems; and
wherein (b) comprises acquiring the first accessible wireless communications system when the first accessible wireless communications system is included in the list of one or more negative wireless communications systems and when the most recently used system is not accessible.

8. The method of claim 1, wherein the first and second wireless communications systems are each code division multiple access (CDMA) cellular systems.

9. The method of claim 8, wherein one or both of the first and second wireless communications systems are CDMA2000 systems.

10. An apparatus, comprising:
a storage unit to store a list of one or more preferred wireless communications systems;
a transceiver to exchange wireless signals from one or more remote devices;
a controller to
identify a first accessible wireless communications system, wherein the first accessible wireless communications system is absent from the list of one or more preferred wireless communications systems,
direct the transceiver to acquire the first accessible wireless communications system,
identify a second accessible wireless communications system after acquiring the first accessible wireless communications system,
direct the transceiver to acquire the second accessible wireless communications system when the second wireless communications system is included in the list of one or more preferred wireless communications systems.

11. The apparatus of claim 10:
wherein the storage unit is to store a list of one or more negative wireless communications systems; and
wherein the controller is to direct the transceiver to acquire the first accessible wireless communications system when the first accessible wireless communications system is absent from both the list of one or more preferred wireless communications systems and the list of one or more negative wireless communications systems.

12. The apparatus of claim 10, wherein the controller is to direct the transceiver to relinquish the first wireless communications system after acquisition of the second wireless communications system.

13. The apparatus of claim 10, wherein the first and second wireless communications systems are each code division multiple access (CDMA) cellular systems.

14. The apparatus of claim 13, wherein one or both of the first and second wireless communications systems are CDMA2000 systems.

15. The apparatus of claim 10, wherein the controller is to direct the transceiver to scan for a most recently used system when the first accessible wireless communications system is included in a list of one or more negative wireless communications systems.

16. The apparatus of claim 15, wherein the controller is to direct the transceiver to acquire the first accessible wireless communications system when the first accessible wireless communications system is included in the list of one or more negative wireless communications systems and when the most recently used system is not accessible.

17. The apparatus of claim 10, wherein the controller is to designate the second accessible wireless communications system as a negative system when it has a negative system ID, and otherwise designate the second accessible wireless communications system as an available system.

18. An article comprising a machine-readable storage medium containing instructions that if executed enable a system to:
identify a first accessible wireless communications system, wherein the first accessible wireless communications system is absent from a list of one or more preferred wireless communications systems;
acquire the first accessible wireless communications system;
identify a second accessible wireless communications system after acquiring the first accessible wireless communications system;
acquire the second accessible wireless communications system when the second wireless communications system is included in the list of one or more preferred wireless communications systems.

19. The article of claim 18, wherein the machine-readable storage medium contains instructions that if executed enable the system to acquire the first accessible wireless communications system when the first accessible wireless communications system is absent from both the list of one or more preferred wireless communications systems and a list of one or more negative wireless communications systems.

20. The article of claim 18, wherein the machine-readable storage medium contains instructions that if executed enable the system to:
scan for a most recently used system when the first accessible wireless communications system is included in a list of one or more negative wireless communications systems; and
acquire the first accessible wireless communications system when the first accessible wireless communications system is included in the list of one or more negative wireless communications systems and when the most recently used system is not accessible.
